(19) United States
(12) Patent Application Publication
(10) Pub. No.: US 2026/0204732 A1
(43) Pub. Date: Jul. 16, 2026

(54) DEVICE FOR MANAGING THE BREATHABILITY AND PRESSURE OF A BATTERY PACK WITH SAFETY DISCHARGE

(71) Applicant: BONTAZ CENTRE, MARNAZ (FR)

(72) Inventor: Clément BLANCHARD, FILLIERE (FR)

(21) Appl. No.: 19/138,301

(22) PCT Filed: Dec. 8, 2023
(86) PCT No.: PCT/FR2023/051960

§ 371 Date: Jul. 17, 2025

(30) Foreign Application Priority Data
Dec. 9, 2022 (FR) 2213097

(51) Int. Cl. H01M 50/30; H01M 10/0525; H01M 50/204; H01M 50/249; H01M 50/289; H01M 50/333; H01M 50/342; H01M 50/367; H01M 50/375

(52) U.S. Cl. CPC H01M 50/394; H01M 50/249; H01M 50/289; H01M 50/333; H01M 50/3425; H01M 50/367; H01M 50/375; H01M 10/0525; H01M 50/204; H01M 2200/10; H01M 2200/20

(57) ABSTRACT

A device to store electrochemical energy, for example a battery, preferably a lithium-ion battery. The device includes at least one first enclosure and at least one second enclosure. The first enclosure contains one or more energy storage elements, for example one or more battery banks. The first enclosure also includes at least one breathing element. The second enclosure is in fluid communication with the first enclosure and is provided with at least one venting element.

### TECHNICAL FIELD AND PRIOR ART

The invention relates to the field of energy storage means or systems (also called ESS), these storage means implementing solutions of the electrochemical type, in particular of the type that make it possible to recharge and discharge on demand in order to be able to transform electrical energy into chemical potential and vice versa.

The invention relates, for example, to batteries, in particular lithium-ion batteries which are made of a sealed casing comprising a set of unit cells and most often electronic and power components for their interconnection and control. Battery technologies are indispensable today, with increasing energy densities and evolving architectures.

ESS can be used in the context of stationary energy storage, for example energy storage containers, or in the context of the transport of goods and/or materials and/or people (in particular in new mobility solutions, for example electric vehicles (automobiles, bicycles, motorcycles, scooters) or hybrid vehicles); the invention therefore applies in particular in the field of transport and mobility in general. It is also used in storage systems with a capacity of several megawatt hours.

Energy storage means can be produced by way of a set of unit cells, for example of the lithium-ion type. The cells can be electrically interconnected to create battery architectures that enable the desired voltage and capacity to be obtained.

In some cases, thermal runaway and/or combustion and/or overpressure can occur within this type of device; gases which can be hot and/or under high pressure and/or dangerous must then be vented. Indeed, overpressures could, for example, cause the casing containing energy storage means or cells, such as those of a battery bank, to burst.

The external environment can be the ambient atmosphere, i.e. an infinite volume having a variable pressure and temperature, the weather conditions and the altitude acting on this pressure and temperature.

However, depending on the intended application, the external environment is not necessarily the ambient atmosphere and may not be suitable for receiving any gases resulting from any of the above-mentioned incidents. Such an immediate environment is, for example, the interior of a habitat or a vehicle for transporting people and/or goods and/or products; the release of gases into the volumes that contain these people and/or goods and/or products should thus be avoided.

The problem therefore arises in finding a new system or device to better manage the atmosphere in the cells, more generally the energy storage means, and the volume in which these cells are arranged.

Moreover, electrochemical storage means, for example fuel cells, are sealed such that they are water-and dust-tight for example; however, the ability to exchange a certain amount of air or gas with the ambient environment, in both directions, is desired, in order to balance the pressure between the interior of the storage means, or of the casing containing them, and the ambient environment. This would reduce the stresses on the casing containing these storage means, facilitate transport and ensure optimal use regardless of the external conditions (temperature and pressure).

The problem therefore arises in finding a system or a device that allows for breathing, or balancing, for example the pressure and/or the temperature and/or another thermodynamic parameter, between the internal atmosphere in a casing or an enclosure of an electrochemical storage means or assembly and the external atmosphere of this casing, wherein this system or device is protected against overpressure inside the casing or enclosure.

The problem also arises in finding a system and a device for venting hot and/or high-pressure gases to an environment that is not an environment that immediately surrounds the cells or the energy storage means or that immediately surrounds the casing or enclosure containing them.

This problem arises in particular in the case of a modular energy storage system, wherein one or more modules can be added or removed in order to vary the storage capacity of the assembly.

### DISCLOSURE OF THE INVENTION

The invention relates in particular to a device for storing electrochemical energy, for example a battery, for example a lithium-ion battery, or to a method for operating such a device, which device comprises:
a 1^{st} casing or enclosure containing one or more energy storage elements, for example one or more battery banks, this 1^{st} casing or enclosure comprising at least one 1^{st} element (or 1^{st} means), for example a 1^{st} breathing valve (or breathing element or means);
a 2^{nd} casing or enclosure, in fluid communication with the 1^{st} casing or enclosure, at least one of the 2 casings or enclosures comprising or being provided with at least one 2^{nd} element (or 2^{nd} means), for example a 2^{nd} vent valve (or venting element or means).

In this application:
the 1^{st} element, or the 1^{st} means, or the breathing element or means, comprises for example a breathing membrane, a filter, a felt, a foam or a breathing valve: it allows breathing, i.e. a fluid exchange, for example a gas exchange, (in both directions) between the interior of this element, or of the volume in which it is provided, and the exterior of this element, or of the volume in which it is provided; and/or
the 2^{nd} element (or the 2^{nd} means), or the venting element or means, allows, for example, venting at least part of a fluid, for example a gas, contained in the 1^{st} casing or enclosure to the 2^{nd} casing or enclosure (which can then store the vented fluid), or to the outside atmosphere (for example if the 1^{st} casing or enclosure is contained in a 2^{nd} casing or enclosure to which it is not possible to vent the fluid or gas).

Subsequently, the terms fluid and gas will be used interchangeably, both of which being concerned by the invention, regardless of the embodiment thereof. The fluid can be, for example, air, or another gas, or a mixture of vapor and combustion gas, or a liquid (for example an electrolyte) mixed with a gas.

The 2^{nd} element, or 2^{nd} means, comprises, for example, a valve or a flap or a seal, for example, which deteriorates or perforates, for example under the action of the atmosphere contained in the 1^{st} casing: it enables fluid to escape from the interior of this element, or from the volume with which it is provided, to the exterior of this element or of this same volume, only in this direction. In the case of a valve, the opening of the valve, which leads to an exhaust, can be reversible; on the other hand, in the case of a flap or seal that deteriorates or perforates, the opening which leads to an exhaust is typically irreversible.

For example, the 2^{nd} element enables a fluid to vent or escape when at least one thermodynamic parameter of the internal atmosphere of the casing in which it is provided and/or the difference in a thermodynamic parameter between the internal atmosphere of this casing in which it is provided and the external atmosphere, and/or a change in this thermodynamic parameter, is higher than at least one limit value or threshold; said at least one thermodynamic parameter, and/or the difference thereof between the internal atmosphere and the external atmosphere, and/or its change, comprises for example at least the pressure and/or the temperature, and/or the pressure and/or the temperature difference between the internal atmosphere and the external atmosphere and/or a pressure and/or temperature change in the internal atmosphere and/or the external atmosphere; and/or venting may also take place when the voltage of one or more energy storage elements, for example at the terminals of these one or more energy storage elements and/or a voltage supplied thereby is lower or higher than a limit value or a threshold.

The 2^{nd} casing or enclosure may be intended to receive and store the gas that escapes, or is vented, from the 1^{st} casing or enclosure via the 2^{nd} element, or the 2^{nd} means.

In a device or method according to the invention, the 2^{nd} casing or enclosure:
may be arranged at a distance from the 1^{st} casing or enclosure; and/or
may be in fluid communication with the 1^{st} casing or enclosure by way of means, for example at least one duct, tube or channel, these means being preferably soft or flexible, for circulating, guiding or conveying a fluid, for example a gas, from the 1^{st} casing to the 2^{nd} casing or enclosure.

The 2^{nd} element, or the 2^{nd} means, could possibly be mounted or disposed at the inlet (or upstream), and/or in, or at the outlet (or downstream) of the means for circulating, guiding or conveying a fluid from the 1^{st} casing to the 2^{nd} casing or enclosure.

According to one variant, a wall is shared by the 2 enclosures, and the 2^{nd} element, or the 2^{nd} means, is/are arranged or mounted so that gas contained in the 1^{st} casing or enclosure could escape, or be vented, from the 1^{st} casing or enclosure to the 2^{nd} casing or enclosure; for example: the 2^{nd} element, or the 2^{nd} means, is/are for example arranged or mounted in a wall, at the interface of, or shared by, the 2 enclosures.

In these 2 cases, the 1^{st} casing or enclosure may be contained in the 2^{nd} casing or enclosure, or in a 3^{rd} casing or enclosure that is different from the 2^{nd} casing or enclosure. The 3^{rd} enclosure may be in fluid communication with the 1^{st} enclosure, for example via the 1^{st} element, for example a 1^{st} valve, breathing then taking place between the atmosphere inside the 1^{st} casing or enclosure and the 3^{rd} casing or enclosure and possibly with exhaust taking place to the 2^{nd} casing or enclosure.

In a device or method according to the invention, the 2^{nd} enclosure or the 3^{rd} enclosure may:
have a volume equal to, for example, at least twice or at least 5 times, or at least 10 times the internal volume of the 1^{st} casing or enclosure; and/or
have at least one wall through which pass means, for example a duct, tube or channel, enabling the gas to escape from the 1^{st} casing or enclosure to, for example, the 2^{nd} casing or enclosure.

In a device or a method according to the invention, at least three volumes can be defined:
the internal volume of the one or more energy storage elements,
the internal volume of the 1^{st} casing or enclosure, which contains or is capable of containing these one or more energy storage elements;
the volume of the 2^{nd} casing or enclosure, which is equal to, for example, at least twice or at least 5 times, or at least 10 times the internal volume of the 1^{st} casing or enclosure.

In a device or method according to the invention, a volume of the 2^{nd} enclosure or of the 3^{rd} enclosure equal to at least twice or at least 5 times, or at least 10 times the internal volume of the 1^{st} casing or enclosure allows recovering combustion gases from the battery (or more generally from the electrochemical energy storage device) which originate from the 1^{st} casing or enclosure, which are hot and will be able to cool down in a larger volume.

The 2^{nd} casing or enclosure may be completely separated from the 1^{st} casing, or share a wall therewith (see the example above), or may completely contain the 1^{st} casing or enclosure: in the latter case, a gas or an atmosphere can flow from the 1^{st} casing or enclosure to the 2^{nd} casing or enclosure (and vice versa) via the 1^{st} element or the 1^{st} valve; possibly, according to some embodiments, it can also escape from, or to, the 2^{nd} casing or enclosure via the 2^{nd} exhaust element, or 2^{nd} exhaust means: in one case, it is the fluid, for example a gas, contained in the 1^{st} casing or enclosure that can escape to the 2^{nd} casing or enclosure; in another case, it is the fluid or gas contained in the 2^{nd} casing or enclosure that can escape.

The 1^{st} casing or enclosure, which contains or is capable of containing one or more energy storage elements, is preferably sealed, in particular water-tight and/or dust-tight, except where the one or more breathing and/or exhaust elements (for example the one or more valves) are arranged.

As a result, the volume that contains the one or more energy storage elements is different from the volume of the external environment and the temperature and/or pressure in this volume is typically different from the temperature and/or pressure of the external environment. However, in a device or method according to the invention, the breathing element allows avoiding stresses on the enclosure containing one or more energy storage elements, which stresses result, for example, from the pressure difference between the internal volume (containing the one or more energy storage elements) and the external environment; thus, the pressure is balanced between the internal volume and the external environment by passing a proportion of air in either direction throughout the 1^{st} element, for example a valve or a breathing membrane, a filter, a felt, or a foam.

According to one embodiment, a device according to the invention comprises, or a method according to the invention implements, a plurality of energy storage elements, each element forming a 1^{st} enclosure and being disposed in a module separated from each of the neighboring modules by a wall, which may be sealed, the 2^{nd} enclosure comprising a venting element, for example a vent valve, for each of said modules.

In a device or method according to the invention, at least one venting element, for example a vent valve, can also be a breathing element, for example a breathing valve.

According to one embodiment, this venting and breathing element, or valve, comprises a first and a second passage for a fluid entering or leaving the enclosure provided with said element, and:
the first passage comprises a closing member, for example a closing piston, and
the second passage comprises a fluid-permeable closing membrane.

The closing member can be configured to open the first passage when a first pressure present in the first passage exceeds a first threshold; preferably the membrane is configured to rupture when a second pressure present in the second passage exceeds a second threshold, the first threshold being lower than the second threshold.

Such an element, for example such a venting and breathing valve, can comprise one or more of the following features:
a resilient element, preferably a spring, configured to exert pressure on the piston to close the first passage; and/or
the membrane has an air permeability that allows, under a pressure difference of Ap 70 mbar, between 1 and 500 liters of air per hour and per cm² of membrane surface to pass; and/or
a filter, preferably a metal mesh, at an outlet of the first passage; and/or
a sensor configured to indicate an opening state of the closing member; and/or
an actuator configured to move the piston to open or close the first passage.

In a device or method according to the invention, at least one breathing element, for example a breathing valve, can comprise means, for example a piston, forming an opening and closing flap of said breathing element.

For example, this element, for example this valve, further comprises:
a body, for example a valve body; and/or
a membrane support for supporting a membrane and allowing for circulation between an outside atmosphere and the atmosphere inside the breathing element; and/or
activation means for activating the flap-forming means between a first so-called open position of the breathing element and a second so-called closed position of the breathing element, these activation means allowing, in said first position, for circulation between the atmosphere inside and the atmosphere outside the breathing element, and closing, in said second position, said circulation.

According to one embodiment, the activation means allow, in said first position, for circulation between the atmosphere inside and the atmosphere outside the breathing element, when at least one thermodynamic parameter of the internal atmosphere or the difference in a thermodynamic parameter between the internal atmosphere and the external atmosphere, or a change in this thermodynamic parameter, is below a limit value, and closing, in said second position, said circulation, for example when said thermodynamic parameter, or the difference thereof between the internal atmosphere and the external atmosphere, or the change thereof, is greater than the limit value.

Said at least one thermodynamic parameter, or the difference thereof between the internal atmosphere and the external atmosphere, or the change thereof, can comprise at least the pressure and/or temperature, or the pressure and/or temperature difference between the internal atmosphere and the external atmosphere and/or a pressure and/or temperature change between the internal atmosphere and/or the external atmosphere.

The flap-forming means can comprise one or more of the following features:
they abut against an inner part of the body of the element, for example the valve, when at least one thermodynamic parameter, for example the pressure and/or temperature of the internal atmosphere and/or of the external atmosphere, is greater than a limit value or when the temperature and/or pressure difference between the internal atmosphere and the external atmosphere is greater than a limit value; and/or
they comprise a piston; and/or
they comprise a part in contact with the internal atmosphere of the valve and a part in contact with the external atmosphere of the valve; this enables the flap forming means to be truly sensitive to a difference, for example a pressure difference, between the internal atmosphere and the external atmosphere of the valve; and/or
they can move according to a stroke which is limited, in the first position, by a stop, located for example on the internal side or on the external side of the element; and/or
they comprise a shaft that penetrates a central extension of the membrane support.

Such an element, or such a valve, can comprise means for constraining the flap-forming means in the open position, for example up to a limit value of a thermodynamic parameter of the atmosphere, these means comprising, for example, a spring bearing on the one hand against the flap-forming means and on the other hand against the membrane support.

In a device or method according to the invention:
at least one venting element, for example a vent valve, or at least one breathing element, for example a breathing valve, comprising means, for example a piston, forming an opening and closing flap of this element, can comprise activation means comprising an actuator and means for moving, for example mechanical means and/or electromagnetic means for driving said valve, or a member for opening or closing said element (for example the flap-forming means mentioned above for a venting and breathing element; for example, the actuator-forming means actuate a rod or a bar mechanically connected to the flap-forming means, for example to the piston or to the rod extending therefrom); and/or
a device according to the invention comprises, or a method according to the invention implements, at least one pressure and/or temperature and/or voltage sensor for measuring:
   at least one pressure and/or temperature inside and/or outside at least one element, for example a breathing or exhaust element or an enclosure (for example the 1^{st} and/or the 2^{nd} enclosure and/or the 3^{rd} enclosure of a device according to the invention) and/or the voltage of one or more energy storage elements, for example at the terminals of these one or more energy storage elements and/or a voltage supplied thereby, and/or
   a change in this pressure and/or temperature inside the valve and/or outside the valve element or said enclosure and/or a change in this voltage; and
optionally means, for example one or more connections between said at least one such sensor and an actuator as mentioned above, for providing the actuator with the information relating to said pressure and/or temperature and/or voltage or the change thereof.

According to one embodiment, at least one pressure sensor and/or at least one temperature sensor is provided inside the element, for example the valve, or the enclosure, and/or at least one pressure sensor and/or at least one temperature sensor is provided outside the element, for example the valve, or the enclosure, and/or at least one voltage sensor is provided, and/or a method according to the invention implements one or more of said sensors.

In a device or method according to the invention, at least one venting or breathing element can be associated with, or provided with, at least one filter. At least one such filter can be arranged:
downstream of said venting element, in the direction of flow of a fluid from the interior to the exterior of an enclosure provided with this venting element, for example with this vent valve; and/or
upstream of said breathing element, in the direction of flow of a fluid from the exterior to the interior of an enclosure provided with this breathing element.

More generally, the invention (device or method) further relates to or implements at least one breathing or venting element, for example for an enclosure of an electrochemical energy storage device, for example a battery, for example a lithium-ion battery; this element is for example at least one breathing or venting element as described above or in the remainder of the present application. Such a breathing or venting element can be associated with, or provided with at least one filter. Such a filter can be arranged:
for a venting element: downstream of said element, in the direction of flow of a fluid from the interior to the exterior of an enclosure provided with this venting element;
for a breathing element: upstream of said element, in the direction of flow of a fluid from the exterior to the interior of an enclosure provided with this breathing element.

Such a breathing or venting element, associated with or provided with a filter, can be applied to a device according to the invention.

A device or method according to the invention can further comprise or implement means for detecting a failure in one or in the energy storage device. Such a failure can consist in detecting an abnormal temperature and/or pressure within the device and/or a voltage of the device or of the energy storage enclosure or of one or more energy storage elements contained therein, and/or in detecting an abnormal change in one of these parameters. These means can comprise one or more temperature and/or pressure and/or voltage sensors, for example as already explained above. Means, for example a computer or a processor, can be programmed to emit a fault signal and/or to close or open one or more breathing or venting elements, depending on the signals provided by the detection means.

The invention further relates to a vehicle comprising a passenger compartment and/or a storage area, an engine, and at least one energy storage device according to the invention, as described above or in the remainder of the present application, wherein at least one venting element, for example a vent valve, allows the gas to escape to outside the passenger compartment and/or storage area. For example, at least one breathing element, for example a breathing valve, can be in fluid communication with the passenger compartment and/or storage area, and at least one venting or exhaust element, for example a vent or exhaust valve, allows the gas to be vented or to escape to outside the passenger compartment and/or storage area.

Such a vehicle is, for example:
of the type intended to transport people and/or goods; and/or
of the autonomous type; and/or
of the motor vehicle and/or construction vehicle type, for example of the excavator or shovel loader type, or of the aircraft or spacecraft type, or of the type used for maritime transport, for example a ship, vessel, boat or submarine, or of the type used for rail transport, for example a locomotive or railroad car.

The invention also relates to a system for producing and storing energy, comprising means for generating or transforming energy, for example photovoltaic energy (or energy from other means for energy production (of the so-called “renewable” and/or intermittent energy type), for example of wind origin, or microhydraulic, or electrical energy resulting from a transformation by an industrial process-for example a process of the co-generation type), and a storage device according to the invention, as described above or in the remainder of the present application, allowing storing the energy produced by said means.

The invention further relates to a method for operating an electrochemical energy storage device, for example a device according to the invention, or a device comprising:
at least one 1^{st} enclosure containing one or more energy storage elements, for example one or more battery banks;
at least one 2^{nd} enclosure in fluid communication with the 1^{st} enclosure, in which method:
at least part of a fluid, for example a gas, contained in the 1^{st} enclosure is renewed by, or through, a 1^{st} element, for example a 1^{st} so-called breathing valve;
at least part of the fluid contained, respectively in the 1^{st} enclosure or 2^{nd} enclosure, is vented, respectively to the 2^{nd} enclosure or to the exterior thereof, by a 2^{nd} element, for example a 2^{nd} so-called vent valve, for example when a threshold for at least one thermodynamic parameter, for example the pressure and/or the temperature, is exceeded in said 1^{st} enclosure.

The fluid, for example a gas, vented towards the 2^{nd} enclosure, can remain stored in the latter. As already explained above, the fluid can be for example air, or another gas, or a mixture of vapor and combustion gas, or a liquid (for example an electrolyte) mixed with a gas.

At least one sensor as described above can be implemented with a method according to the invention, optionally making it possible to activate an actuator of one or more breathing and/or venting elements, for example one or more valves, and/or an actuator of a member thereof.

All or part of the aspects implemented in the case of a device and described above or in the remainder of this description or in the figures can be implemented with a method according to the invention.

### BRIEF DESCRIPTION OF THE DRAWINGS

FIG. 1A shows a 1^{st} example embodiment of a device according to the invention;

FIG. 1B shows a 2^{nd} example embodiment of a device according to the invention;

FIG. 2 shows a 3^{rd} example embodiment of a device according to the invention;

FIG. 3 shows a 4^{th} example embodiment of a device according to the invention.

FIG. 4 shows a 5^{th} example embodiment of a device according to the invention.

FIG. 5 shows a breathing valve that can be implemented in a device according to the invention;

FIG. 6A and FIG. 6B show an exhaust valve that can be implemented in a device according to the invention;

FIG. 7A and FIG. 7B show a breathing and exhaust valve that can be implemented in a device according to the invention;

FIG. 8, FIG. 9, FIG. 10A, FIG. 10B, FIG. 11A, FIG. 11B, FIG. 11C and FIG. 11D show an exhaust valve with a closing flap, which exhaust valve can be implemented in a device according to the invention;

FIG. 12A and FIG. 12B show an exhaust valve combined with a filter and a breathing valve combined with a filter, which can be implemented in a device according to the invention;

FIG. 13A and FIG. 13B show various vehicles or machines: motor vehicle, aircraft, boat, locomotive, provided with an energy storage device according to the invention; and

FIG. 14 shows another application of a device or of a method according to the invention.

### DETAILED DISCLOSURE OF SPECIFIC EMBODIMENTS

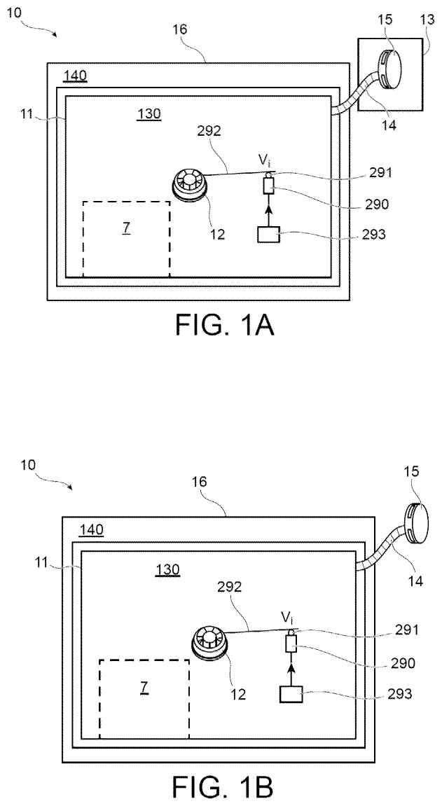

FIG. 1A shows a 1^{st} example embodiment of a system 10 according to the invention or which can be implemented in the case of a method according to the invention.

A 1^{st} casing or enclosure 11 contains one or more energy storage elements, for example one or more battery banks. It is provided with a 1^{st} element, for example a breathing membrane, or a filter, a felt, a foam or a breathing valve 12 (in the remainder of this description, the example of a valve is considered; however, the invention also applies to the case of a 1^{st} breathing element of any other type of the types listed above), which enables the air or atmosphere to circulate between the volume 140 outside the casing 11 and the internal volume 130 of the casing 11. The reference numeral 7 denotes means for storing energy, for example in electrochemical form, contained in the enclosure 11 (in the following text, the expression “casing” or “enclosure” is used indifferently).

A 2^{nd} casing or enclosure 13 is, in this example, physically separated from the 1^{st} enclosure 11, to which it is connected by an element or means 14 such as a duct, a tube or a channel 14, which is, for example, soft or flexible; in this case, the 2 enclosures may be located at a distance from one another. A gas or an atmosphere can circulate between these 2 enclosures via this element 14.

The 1^{st} enclosure 11 is provided with an element, for example an exhaust or discharge or vent valve 15, which enables the air or the atmosphere to escape from this 1^{st} enclosure 11 towards the 2^{nd} enclosure 13. In the remainder of this description, the example of a valve is considered; however, the invention also applies to the case of a 2^{nd} venting element of another type (for example a flap or a seal, which, for example, degrades or is perforated, under the action of the atmosphere contained in the 1^{st} casing). In the event of overpressure and/or heating in this 1^{st} enclosure, the over-pressurized and/or overheated gases escape through this valve 15. In particular, overpressure and/or heating in this 1^{st} enclosure may be due to overpressure and/or heating, for example because of a thermal runaway in the one or more batteries.

As illustrated in FIG. 1A, the 1^{st} enclosure may be contained in a 3^{rd} casing or enclosure 16, for example of the type in which over-pressurized and/or heated gases in the 1^{st} enclosure cannot be vented: this is in particular the case if this enclosure 16 contains, or is intended to contain, passengers, and/or equipment and/or products and/or goods which cannot be in contact with said over-pressurized and/or heated gases in the 1^{st} casing. On the other hand, pressure and/or temperature balancing (i.e. the breathing function) can be carried out with the atmosphere contained in this enclosure 16. The latter is, for example, a passenger compartment of a vehicle, or the interior of a railroad car, or an aircraft cabin or cargo hold, or the interior of a submarine, or the interior of a space station.

In this case of the 1^{st} enclosure contained in a 3^{rd} enclosure 16, the duct 14 passes through a wall 17 of this 3^{rd} enclosure 16 to convey the gases to the 2^{nd} enclosure, from where they are vented by the vent valve 15, as soon as they have a pressure and/or a temperature that exceeds a certain threshold.

FIG. 1B shows a 2^{nd} example embodiment of a system 20 according to the invention. The same reference numerals are used to denote identical elements in FIG. 1A. In fact, this figure is identical to that of FIG. 1A, except in that the gas contained in the 1^{st} enclosure is vented to the outside atmosphere and is not stored in an enclosure. The enclosure 16 may be considered to be the 2^{nd} enclosure: the enclosure 11 exchanges gas with the volume 140 (by breathing), but at least part of its gas can be vented via the means 14, 15.

In each of FIGS. 1A and 1B, the valve 15 can be disposed at various locations of the means 14, for example at the inlet, inside, or at the outlet of these means 14.

In each of FIGS. 1A and 1B, a variant is also shown wherein the valve 12 is provided with actuation means comprising, for example, a member 292 which, cooperating with an actuator 290, for example an electric motor, allows actuating, via a transmission member 291, the valve (or a member of the latter), to open or close, or to move in either direction, for example along an axis AA′. The member 292 comprises, for example, a rod or a bar of which a part is filled with notches or teeth, thus forming a rack, which can be set in motion by the member 291, which comprises, for example, a toothed wheel. Other examples of drive means can be implemented, for example electromagnetic drive means, as described below. Alternatively, or additionally, the one or more valves 15 can be provided with such a system or with one of its alternative embodiments. The various valves described in the context of the various examples below can also be provided with such an opening/closing actuation system.

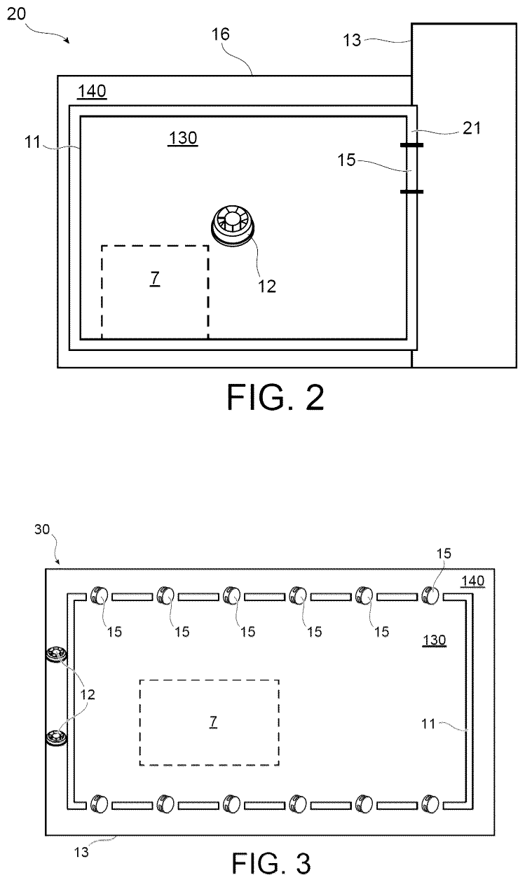

FIG. 2 shows a 3^{rd} example embodiment of a system 20 according to the invention or which may be implemented in the case of a method according to the invention.

Although the 2^{nd} casing or enclosure 13 is, again, physically separated from the 1^{st} casing or enclosure 11, they both have a shared wall 21, which may be provided with a venting element 15, for example a valve, through which the gases can be vented from the 1^{st} casing 11 to the 2^{nd} casing 13. The wall 21 may be sealed between the 1^{st} casing or enclosure 11 and the 2^{nd} casing; it may be provided to have an increased structural capacity, for example so that pressure balancing through this wall is not necessary; alternatively, this wall may be porous. Alternatively (not shown), an element 14 such as a duct, a tube or a channel, which is, for example, soft or flexible, can pass through the wall 21 and convey the vented gas into the 2^{nd} casing 13, and the venting element 15 may be arranged at various locations of the means 14, for example at the inlet, inside, or at the outlet of these means 14.

FIG. 3 shows a 4^{th} example embodiment of a system 30 according to the invention or which may be implemented in the case of a method according to the invention.

The 1^{st} casing 11 is wholly contained in a 2^{nd} casing 13. However, the 1^{st} casing 11 is provided with one or more vent valves 15 and at least one breathing valve 12; the one or more breathing valves is/are:
for example located on the top or on one side of the battery casing 11; and/or
on a wall that is identical to the one or more vent valves 15, or on a different wall.

The one or more vent valves 15 are normally closed and breathing occurs via the valves 12, for example with the volume 140 outside the casing 13. In the event of overpressure and/or heating in the 1^{st} casing, the one or more vent valves 15 is/are opened (and venting takes place to the volume 140), whereby at least one valve 12 can either be open following destruction of a membrane, or for example be closed, for example by mechanical means such as a piston.

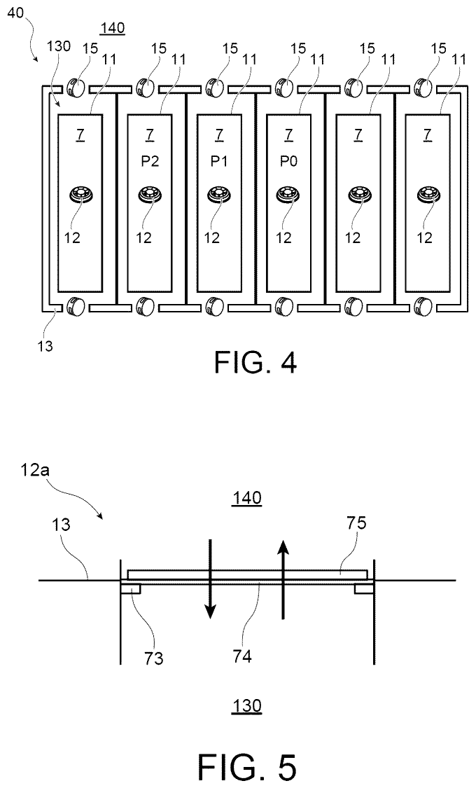

FIG. 4 shows a 5^{th} example embodiment of a system 40 according to the invention or which may be implemented in the case of a method according to the invention.

It comprises a plurality of modules or sections, each forming a 1^{st} enclosure 11, which is provided with at least one breathing valve 12 (for breathing with the external volume 140) and is separated from each neighboring module by a sealed wall 111 of a 2^{nd} enclosure 13. This 2^{nd} enclosure is provided with at least one vent valve 15 for each 1^{st} casing. This architecture can be modulated as desired, by adding or removing modules, thereby allowing designing a modular battery, each module being provided with a breathing valve 12, a corresponding exhaust valve 15 being provided in the 2^{nd} enclosure 13.

In the case of a thermal runaway or, more generally, if a pressure and/or temperature threshold or a threshold of another of the parameters mentioned in the present application (thermodynamic parameter and/or voltage value) is exceeded, the breathing element 12 can be open or closed, whereas the venting element 15 will be open, with venting taking place to the outside atmosphere 140.

Examples of breathing valves or flaps and of exhaust valves or flaps that can be implemented in the context of the present invention are described below.

A breathing valve or flap 12a comprises, for example (FIG. 5), a body 72, that is for example substantially cylindrical (other shapes nonetheless are possible) in which a support 74 of a membrane 75 is positioned, which for example comes to rest against a lip 73. This support 74 is mainly planar and is provided with perforated zones that will allow an atmosphere to circulate between the internal volume 130 and the external volume 140 of the valve, and therefore of the enclosure 13, which is preferably sealed (alternatively, this could be the enclosure 11 or 16) and on which the valve is mounted. A porous membrane 75 can be welded onto this support, for example using an ultrasonic technique. The membrane is for example an e-PTFE membrane or an open-pore foam. During the phases of normal operation, it allows the pressures between the interior 130 and the exterior 140 of the enclosure to be balanced.

A vent or exhaust valve or flap allows the gas or atmosphere contained in the volume which is provided with this valve to escape when, for example, a temperature and/or a pressure inside this volume and/or, more generally, a thermodynamic parameter of the atmosphere inside the volume, exceeds a certain threshold value, which can be set by the stiffness of a spring.

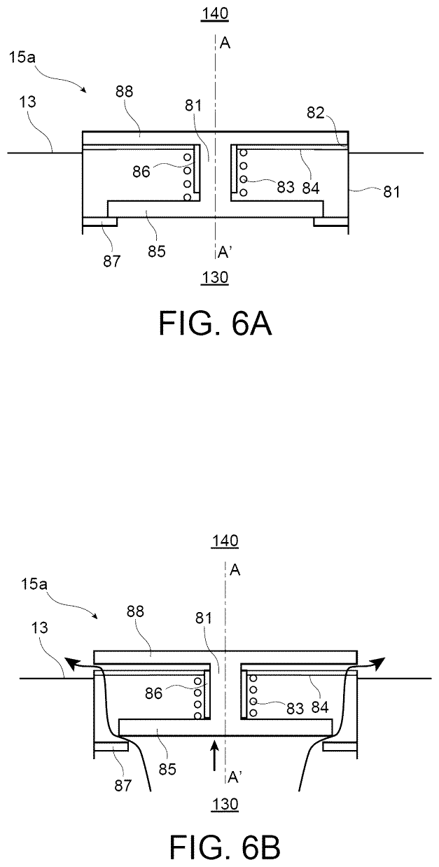

An example of such a valve 15a providing this function is described below with reference to FIGS. 6A and 6B.

It comprises an unmoving body 81 placed in a dedicated orifice in an enclosure 13 which is preferably sealed (alternatively, this could be the enclosure 11 or 16).

In this example, this body is rotationally symmetrical about an axis AA′. However, other shapes can be produced, for example a rectangular or square-shaped valve can be used. It has an orifice 82 in which a perforated support 84 is positioned (the perforations allowing the fluid to pass when the valve is opened), and which can comprise, or be extended by, a central cylindrical portion 86, which extends towards the interior of the casing and within which a shaft 81 (or a rod or bar) of a piston 88, forming a flap, will be able to slide. At the end of this shaft opposite the piston 88 there is a bearing plate 85 which rests on a lip 87. In the shape shown, the piston or valve is circular in shape and adapted to that of the valve shown. However, if the latter has another shape, for example a rectangular or square shape as already mentioned above, then the piston or the flap has a matching shape. A spring 83 compressed between the inner surface of the support 84 and the plate 85 holds this piston 88 in a normally closed position, preventing an atmosphere from circulating between the internal volume 130 and the external volume 140 of the casing, in one direction or the other. Preferably, one or more seals (not shown) make it possible to seal the displacement of the shaft 81 in the central cylindrical portion 86.

The length of the central cylindrical portion 86 is shorter than the distance between the inner surface of the support 84 and the upper surface of the plate 85, thus forming a stop ending the travel of the plate 85 when the internal pressure exceeds a threshold determined by the characteristics of the spring.

When the pressure of the internal volume 130 exceeds a limit value, pushing back the spring 83, the piston 88 is moved into its open position (FIG. 6B).

According to a preferred embodiment, the piston as well as its shaft 86 are rotationally symmetrical about the axis AA′. However, as already explained above, other shapes of the valve and the piston may be used. The piston moves in translation along this axis AA′, in this example under the action of the spring 212 and/or of a pressure or a pressure difference between the interior and the exterior of the enclosure 13. If the valve and the piston or flap have a shape that is different to a circular shape, the piston or flap can nonetheless move in translation along an axis AA′, preferably substantially perpendicular to the wall 13 in which the valve can be installed.

When the pressure difference between the interior 130 and the exterior 140 of the valve or the enclosure, or the pressure inside the enclosure or the valve, does not exceed a value allowing the spring 83 to be compressed, then the piston remains abutting against the part 84 and the plate 85 against the lip 87, and the atmosphere cannot therefore escape from the enclosure.

When the pressure difference between the interior and the exterior of the valve or the enclosure exceeds the limit value, for example 50 mbar or 70 mbar, or more generally a limit pressure for example between 40 mbar or 50 mbar and 100 mbar, which allows the spring 83 to be compressed, or when the pressure of the internal atmosphere 130 of the enclosure or the valve exceeds a value which allows the spring 83 to be compressed, then the piston is moved to an open position (FIG. 6B), thereby allowing the atmosphere to circulate between the interior and the exterior of the valve or enclosure. Such an overpressure situation can occur, for example, in the case of gas release or a thermal runaway (for example due to a rapid temperature increase and/or an additional volume of combustion gas causing the overpressure). The over-pressurized gases, for example originating from cell combustion, can therefore escape A venting and breathing valve or flap allows ensuring both functions: in “normal” operation, the breathing function is ensured; however, as soon as, for example, the temperature and/or pressure exceeds a certain threshold inside the enclosure provided with said valve, the venting function is implemented and the overheated and/or over-pressurized atmosphere can be vented.

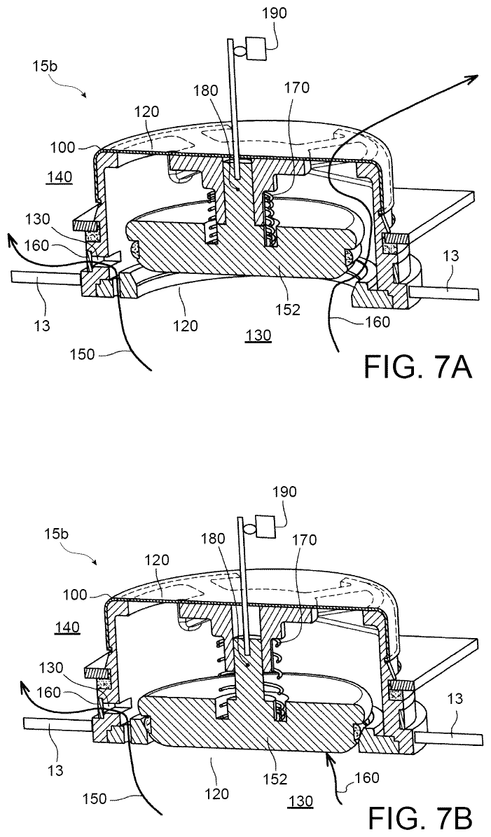

One example of such a valve 15b providing these 2 functions is described below with reference to FIGS. 7A and 7B.

FIG. 7A shows a valve 15b for an enclosure 13 which is preferably sealed (alternatively, this could be the enclosure 11 or 16). The valve comprises a first passage 120 and a second passage 130 for a fluid entering or exiting the enclosure. The first passage of the valve comprises a closing member 152, for example a piston. The second passage comprises a membrane 160. The membrane is permeable to the aforementioned fluid.

The valve is therefore adapted to be positioned in a venting opening or in a venting duct of an enclosure such as the enclosure 11, 13, or 16, which is for example suitable for receiving a battery pack. Such a venting opening or venting duct typically provides a passageway for a fluid to pass between an interior 130 and an exterior 140 of the enclosure. In general, the enclosure can be sealed outside said opening: said opening is then the only exchange path for a fluid between the interior and the exterior of the enclosure.

Once the valve is positioned in the venting opening, the first passage 120 and the second passage 130 have a path for the fluid entering or exiting the enclosure. This allows the fluid to enter or exit the enclosure through the first or second passage of the valve. FIG. 7A shows the fluid passing through the first passage 160 and the fluid passing through the second passage 150.

Advantageously, the membrane 160 only prevents particles, for example dust, from entering from the exterior 140 to the interior 130 of the enclosure, which particles could harm the contents of said enclosure, for example by damaging a battery. Preferably, the air permeability of the membrane under a pressure difference of Δp 70 mbar is between 1 and 500 L·h⁻¹·cm⁻². In other words, the membrane can be permeable to air under a pressure difference: At a pressure difference of Δp 70 mbar, the membrane allows between 1 and 500 liters (L) of air to pass per hour (h) and per cm² of membrane surface. In other words, a membrane with a surface area or size of 1 cm² allows between 1 and 500 liters of air to pass through the membrane in the case where a pressure of 70 mbar is applied through the membrane. For example, said permeability can be determined according to one of the methods defined by standards ISO 5636-3, ISO 5636-4 or ISO 5636-5.

The first passage comprises a closing member 152, for example a piston. This member can move between an open position and a closed position. In the open position, it opens the first passage and the fluid can pass through the first passage and through the second passage between the interior and exterior of the enclosure. FIG. 7A shows this member in its open position and the fluid passing through the first passage 160 opened by this member, which in this case is a piston.

FIG. 7B shows the same valve already shown in FIG. 7A, but with the member 152 being in the closed position. The fluid can still pass through the second passage, through the permeable membrane. The first passage is closed by the member 152, which stops the fluid.

Advantageously, the first passage can comprise a filter 100. The filter can be a metal mesh and have a technically negligible resistance to the passage of the fluid. The filter prevents particles from entering or exiting the enclosure when the piston is in the open position.

FIGS. 7A and 7B show a resilient element 170, configured to exert pressure on the member, in this case a piston, to close the first passage. Preferably, the resilient element is a spring. As shown in FIG. 7B, the spring exerts pressure on the piston to press it with a piston seal against a rim. As a result, the piston is held in the closed position by the pressing force of the spring.

The closing member can be configured to open the first passage under the influence of a pressure present in the first passage. For example, the pressure present in the first passage can increase due to heat development in the enclosure. For example, when the force exerted by the pressure in the first passage exceeds the force exerted by the resilient element on the member 152, the latter moves into the open position. Thus, it is configured to open the first passage when the first pressure present in the first passage exceeds a first pressure threshold.

The membrane can be configured to rupture when a second pressure present in the second passage exceeds a second pressure threshold. In this case, the first pressure threshold is chosen to be lower than the second pressure threshold.

In other words, the membrane can be configured to rupture when a force exerted on the membrane by the pressure present in the second passage exceeds a threshold. For example, a thickness or a material of the membrane can be chosen to have stability configured to rupture when said force exceeds said threshold.

Typically, when the valve is positioned in a venting opening of a battery enclosure, the first pressure present in the first passage is equal to the second pressure present in the second passage, because said two passages both communicate with the interior of the enclosure. Thus, the pressure present in the first and second passages corresponds to the pressure inside the enclosure.

The choice presented above, according to which the first pressure threshold is chosen to be lower than the second pressure threshold, ensures that the closing piston opens the first passage before the membrane is at risk of rupture.

FIGS. 7A and 7B also show a sensor 180 configured to indicate an opening state of the member 152. The sensor can for example be placed on a rod, for example of the piston, and provide an electrical or optical signal indicating an open or closed position of the piston. The sensor 180 can also be located on the cylinder of the piston or on the piston.

The valve can further comprise an actuator 190 configured to move the piston to open or close the first passage. The actuator can for example be an electric motor, a piezoelectric actuator or an electric magnet acting on the piston. Thus, the actuator can actuate the piston between the open position and the closed position. The actuator can be configured to force the piston into a closed position and/or to force the piston into an open position and/or to exert no force on the piston. In the case where the actuator exerts no force on the piston, the opening or closing position is determined only by the forces exerted by the resilient element and the pressure present in the first passage.

Heating in the enclosure provided with such a dual-function member, for example the enclosure 13, 11, or 16, which heating is for example a thermal runaway in one or more battery pack cells, can cause a sharp increase in heat and pressure within the enclosure. When this pressure exceeds a first value, the pressure exerted on the valve closing piston moves the piston to the open position. The fluid can thus be vented from the interior of the enclosure through the first passage of the valve. Advantageously, the filter 100 of the valve prevents particles of the battery from escaping from the enclosure.

Advantageously, the valve membrane is configured to rupture under the influence of a second pressure value present in the enclosure. The first pressure value is lower than the second pressure value.

Apart from the situation involving a thermal runaway or other event generating a pressure of the first pressure value within the enclosure, the valve piston remains in its closed position, if it is not moved by the actuator, as described below. While the piston remains in its closed position, a fluid exchange can take place through the second passage and the permeable membrane. Thus, an increase or decrease in pressure inside the enclosure that remains below said first pressure value is balanced due to the fluid passing through the second passage and the permeable membrane. For example, an increase in pressure inside the enclosure caused by sun exposure is balanced by an exchange of fluid through the second passage. Advantageously, the membrane prevents particles, such as dust, from entering the enclosure.

Preferably, the valve is provided with the actuator configured to displace or move the closing piston. Thus, the piston can for example be positioned in an open position when a sharp increase in pressure inside the enclosure is foreseeable. For example, when transporting a battery by air, the pressure inside the enclosure can rise sharply due to a drop in pressure at the exterior 140 of the enclosure, which can damage the battery. In preparation for air transport, the actuator can be operated in order to move the piston to an open position.

Advantageously, the battery pack comprises a battery management system that is connected to the actuator 190 in order to open or close the first passage. In this way, the battery pressure and operation management can be efficiently controlled by the management system. Control or command means of this valve can be those described below with reference to FIGS. 11A and 11B (reference numeral 290), the valve optionally being provided with one or more sensors 293, 293′, 295, 295′ (see description below).

The embodiment described with reference to FIGS. 7A and 7B can be transformed into a simple vent valve (of the type in FIG. 6A or 6B) by removing the channel 130.

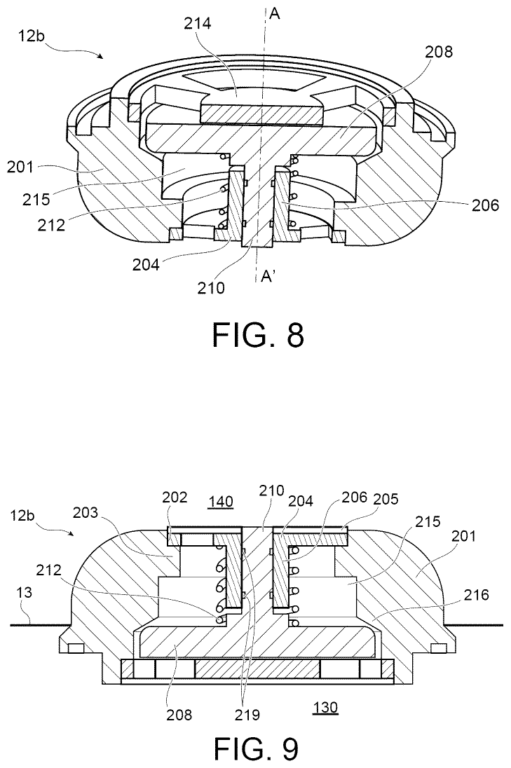

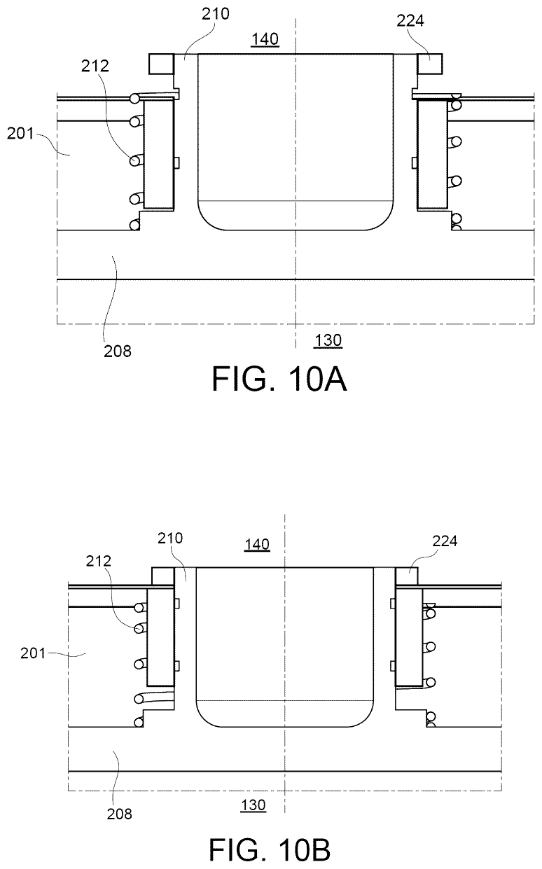

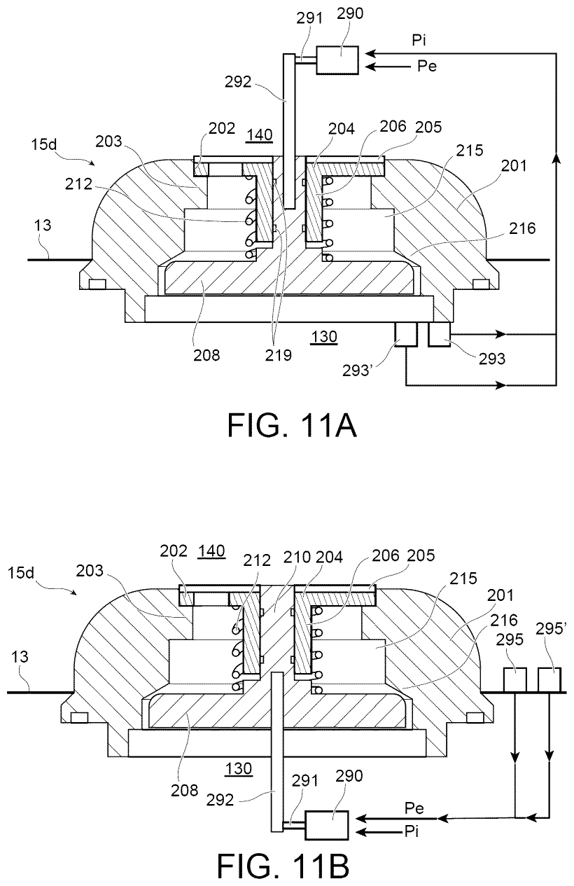

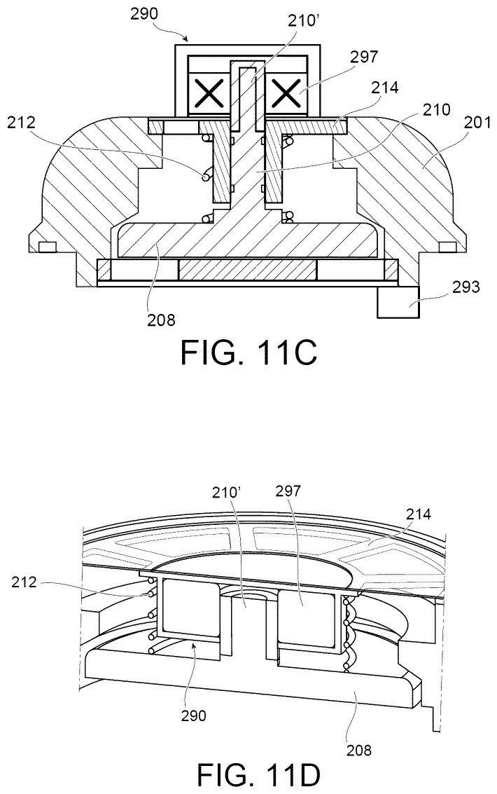

A vent valve or flap normally open, but which can be closed in the event of overpressure and/or heating and ensuring these 2 functions is described below with reference to FIG. 8-11D .

FIGS. 8 and 9 show one example embodiment of such a valve 12b. It comprises an unmoving body 201 placed in a dedicated orifice in an enclosure 13 which is preferably sealed (in this case, and in the other figures, alternatively, this could be the enclosure 11 or 16). In this example, this body is rotationally symmetrical about an axis AA′. However, other shapes can be produced, for example a rectangular or square-shaped valve can be used. It has an orifice 202 in which a membrane support 204 is positioned, which bears against a lip 203. This support is mainly planar and is provided with perforated zones which will allow an atmosphere to circulate between the internal volume 130 and the external volume 140 of the valve, and therefore of the enclosure 13. A porous membrane 205 (FIG. 9) can be welded onto this support, for example using an ultrasonic technique. The membrane is for example an e-PTFE membrane or an open-pore foam. During the phases of normal operation, it allows the pressures between the interior of the volume and the surrounding environment to be balanced.

The support 204 can comprise or be extended by a central cylindrical portion 206, which extends towards the interior of the casing and within which a shaft 210 (or a rod or bar) of a piston 208, forming a flap, will be able to slide. In the shape shown, the piston or valve is circular in shape and adapted to that of the valve shown. However, if the latter has another shape, for example a rectangular or square shape as already mentioned above, then the piston or the flap has a matching shape. A spring 212 holds this piston 208 in a normally open position, allowing an atmosphere to circulate between the internal volume 130 and the external volume 140 of the casing, in one direction or another (thereby providing a breathing function). Preferably, one or more seals 219 provide for a sealed displacement of the shaft 210 in the central cylindrical portion 206. The volume 215, internal to the valve, is either at the internal pressure or at the external pressure depending on the open or closed position of the piston.

A part 214 forming a stop limits the stroke of the piston under the action of the spring. In FIGS. 8 and 9, this part 214 is attached to the body 201, for example on the side of the internal volume 130 of the casing. In other words, the spring can push back the piston until it becomes blocked by the part 214, in a position in which the air or atmosphere can circulate between the external volume 140 and the internal volume 130 of the casing. In an alternative embodiment, which is explained below with reference to FIGS. 10A and 10B, this part forming a stop can be installed at the end of the shaft 210. Preferably, the piston 208 is in direct contact with the internal volume 130 and with the external volume 140 via the end of the shaft 210. Thus, the pressure difference exerted on the piston is indeed the difference between the pressure inside the casing and the pressure outside it. Alternatively, when the internal pressure exceeds a limit value, which value allows the spring 212 to be pushed back, the piston is moved into its closed position.

According to a preferred embodiment, the piston 208 and the shaft 210 thereof are rotationally symmetrical about the axis AA′. However, as already explained above, other shapes may be used. The piston moves in translation along this axis AA′, in this example under the action of the spring 212 and/or of a pressure or a pressure difference between the interior and the exterior of the enclosure 13. If the valve and the piston or flap have a shape that is different to a circular shape, the piston or flap can nonetheless move in translation along an axis AA′, preferably substantially perpendicular to the wall 13 in which the valve can be installed.

According to a first mode of operation, the pressure difference between the interior and the exterior of the valve or the enclosure, or the pressure inside the enclosure or the valve, does not exceed a value that allows the spring 212 to be compressed: the piston remains abutted against the part 214 and the atmosphere can thus circulate between the interior and the exterior of the enclosure, via the membrane, the membrane support and the space provided between the piston 208 and the body 201 (this space is visible in FIG. 9). For example, air flows at a flow rate of between 0.5 and 100 1/min/cm² under a pressure difference of a few tens of mbar, for example between 20 mbar and 40 mbar.

According to a second mode of operation, the pressure difference between the interior and the exterior of the valve or the casing exceeds the limit value, for example 50 mbar or 70 mbar, or more generally a limit pressure for example comprised between 40 mbar or 50 mbar and 100 mbar, which allows the spring 212 to be compressed, or the pressure of the atmosphere inside the casing or the valve exceeds a value which also allows the spring 212 to be compressed. The piston is thus pressed against an inner edge, or lip, 216 of the body 201, thereby stopping the atmosphere from circulating between the exterior and the interior of the valve or casing. This protects the membrane against overpressure inside the valve or enclosure. Such an overpressure situation can occur, for example, in the case of gas release or a thermal runaway (for example due to a rapid temperature increase and an additional volume of combustion gas causing overpressure). Over-pressurized gases, for example gases originating from cell combustion, could potentially escape through other dedicated orifices or pressure relief valves.

FIGS. 10A and 10B show an alternative embodiment of such a valve. In these figures, identical reference numerals to those used in FIGS. 8 and 9 refer to identical or matching elements. The difference with respect to the previous figures lies in the part 224, which forms a stop to limit the stroke of the piston: in this case, this part is located at the end of the shaft 210 and comes into contact with the membrane when the external pressure is greater than the pressure inside the casing (FIG. 10B); the air or atmosphere can then circulate between the exterior and the interior of the casing. When the pressure inside the casing, or the pressure difference between this internal pressure and the external pressure, is such that the piston compresses the spring 212, the piston 208 abuts against the wall of the body 201, thus closing any way for air or atmosphere to be exchanged between the external volume 140 and the internal volume 130 of the casing (FIG. 10A).

FIGS. 11A and 11B show alternative embodiments of such a valve. The valve is provided with a member 292 which, when cooperating with an actuator 290, for example an electric motor, drives, via a transmission member 291, the piston 208 in one direction or the other along the axis AA′. Thus, the piston can be driven into its closed position or, conversely, into its open position. The member 292 is mechanically connected to the flap; for example, it penetrates the shaft or rod 210. This member comprises, for example, a rod or a bar of which a part is fitted with notches or teeth, thus forming a rack, which can be set in motion by the member 291, which comprises, for example, a toothed wheel.

The actuator 290 can control the member 291 under the effect of information relating on the one hand to the pressure Pe, and/or the temperature Te, outside the valve (or outside the casing 30 which is fitted with this valve), and information relating to the pressure Pi, and/or the temperature Ti, inside the valve (or inside the enclosure 13 which is fitted with this valve).

For example, if the means 290, 291 for driving the member 292 are located outside the valve (case of FIG. 11A), the actuator 290 receives information relating to the internal pressure and/or temperature, from a pressure sensor 293 (and/or a temperature sensor 293′), which can be disposed inside the valve or the casing, the external pressure and/or temperature being measured directly using a sensor which can, for example, be comprised in the actuator 290. If the means 290, 291 for driving the member 292 are located outside the valve (case of FIG. 10B), the actuator 290 receives information relating to the external pressure and/or temperature, from a pressure sensor 295 (and/or a temperature sensor 295′), which can be disposed outside the valve or the casing, the internal pressure and/or temperature being measured directly using a sensor which can, for example, be comprised in the actuator 290.

FIG. 11C shows another alternative embodiment of such a valve. The actuating member 290 in this case comprises one or more coils 297 that interact with an end of the shaft or rod 210 of the piston. This shaft or rod comprises a portion (shaft or rod) 210′that extends beyond the membrane support 214 and the membrane and which is at least partially magnetized. Thus, depending on the activation of the one or more coils 297 by an electrical current, the magnetic field produced thereby will interact with the end 210′of the axis 210 to move it along the axis AA′, in one direction or another with a view to opening or closing the breathing valve.

As previously described, the actuator 290 can receive information relating to the internal pressure and/or temperature from a pressure sensor 293 (and/or a temperature sensor), which can be disposed inside the valve or casing, the external pressure and/or temperature being measured directly using a sensor which can, for example, be comprised in the actuator 90.

Alternatively, as shown in FIG. 11D, the same type of drive, by magnetic means, can be implemented on the internal side of the valve, optionally with the one or more pressure and/or temperature sensors arranged accordingly, for example in the manner explained above with reference to FIG. 11B. In this variant, the actuator comprises at least one or more coils 297 (forming a stator) and at least one magnetic part (attached to the valve, for example to the part 210′ of the shaft of the piston) which allow the system to be closed or opened, and even to be opened to a certain degree.

In these various embodiments implementing an actuator (but also in the case of FIG. 1A-4, 6A-6B or 7A-7B):
the actuator 290 can comprise, or be connected to, a circuit, for example an electrical or electronic circuit, comprising for example at least one comparator, which will compare two pieces of information (for example either two pieces of measured information, or one piece of measured information and a predetermined threshold) relating to the internal pressures and/or temperatures Pi and/or Ti and external pressures and/or temperatures Pe and/or Ti, or information based on, or computed from, one and/or the other of these parameters, for example the evolution of one and/or the other of these parameters over time, and, consequently, trigger, or not, the actuation of the member 292 (FIGS. 11A, 11B) or the magnetic means 297 (FIGS. 11C, 11D); alternatively, the actuator or circuit can be provided or programmed to trigger, or not, the actuation of the member 292, 210′ according to a measurement of a pressure/temperature inside the valve or the casing comprised therein. In all cases, this circuit can be a circuit programmed for and/or adapted to this operation or function; and/or
the actuator 290 can allow for an intermediate opening position between the fully closed position of the flap and the fully open position thereof, and/or
the valve can be controlled by an electrical signal sent in the actuator, which signal can, for example, originate from a controller or an external circuit or a circuit located in the valve, which can receive, from one or more sensors, internal and/or external pressure and/or temperature information and/or voltage information provided by, or across the terminals of, an energy storage device, and/or other information causing the valve to close or open; and/or
the valve no longer needs to be provided with the spring 212 or the stopper or stop piece 214, 224, since the movement of the flap is controlled by the means 290; for example, the spring 212 is shown in FIG. 11C or 11D, but could be removed.

In these embodiments, the valve can therefore comprise an actuator 290 configured to move the flap to open or close the atmosphere exchange via the valve. The actuator can, for example, be an electric motor, or a piezoelectric, magnetic or electromagnetic actuator, for example an electric magnet, acting on the flap. Thus, the actuator can move the flap between the open position and the closed position. The actuator can be configured to force the flap into a closed position and/or to force the flap into an open position and/or to exert no force on the flap. The 2 types of exhaust or vent valve or flap (for example those described with reference to FIG. 6A-6B and 7A-7B) can be implemented in the configurations of FIG. 1A-4. However, for the configuration in FIG. 1A or FIG. 1B, it is preferable to implement a vent valve or flap of the type described with reference to FIG. 5; in FIGS. 1A and 1B, it is also possible to implement simple exhaust flaps and a breathing valve, but it is also possible to use a dual-function valve or flap (as explained above with reference to FIGS. 7A and 7B).

The 2 types of exhaust or vent valve or flap (for example those described with reference to FIG. 5 and 8A-11D) can be implemented in the configurations of FIG. 1A-4.

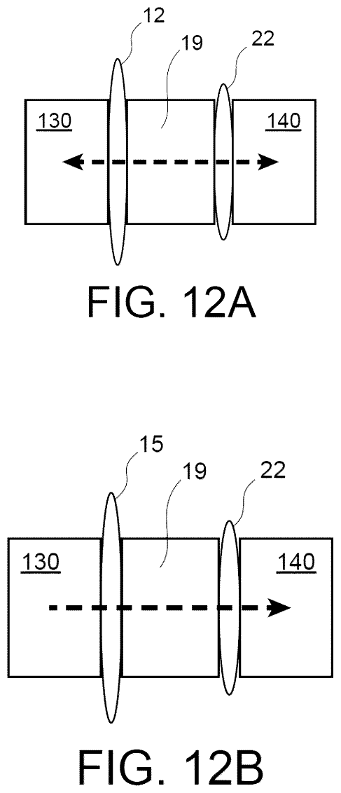

Regardless of the valve selected, whether it is a breathing or vent valve, it can be associated, in a device or a method according to the invention, with a filter. The latter is preferably arranged:
for a breathing valve 12 (FIG. 12A): between this valve and the external environment, the air or gas introduced into the internal volume 130 first passing through the filter 22, then through the valve 12; for example, an intermediate volume 19 can be provided between the breathing valve 12 and the filter 22;
for a vent valve 15 (FIG. 12B): between this valve and the external environment 140, the air or gas vented, for example hot gas or air, passing first through the valve 15, then through the filter 22; more specifically, this hot gas or air can contain particles resulting, for example, from degradation of a battery due to overheating; again, an intermediate volume 19 can be provided between the valve 15 and the filter 22.

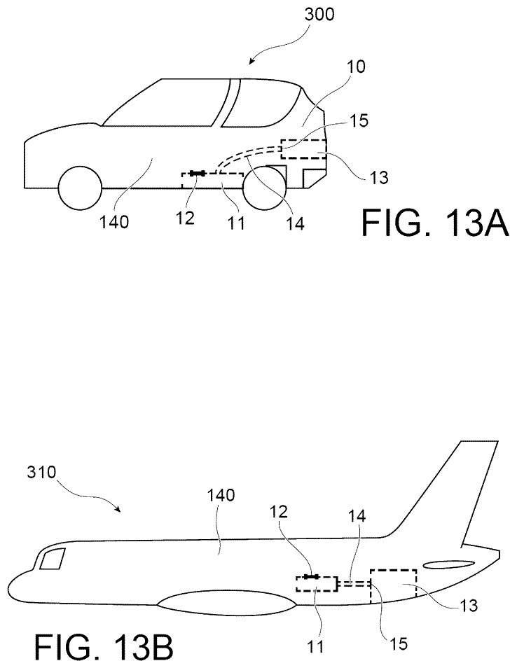

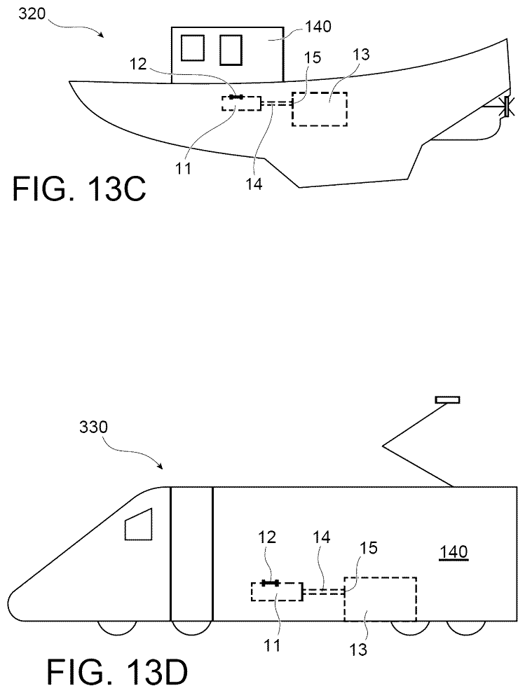

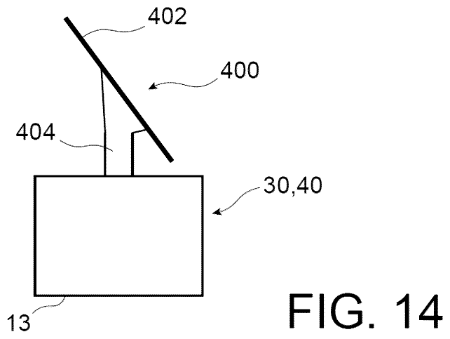

A device according to the invention can advantageously be used to make a battery compartment in the transport field, for example in a car, a truck or an aircraft, propelled by a combustion engine, an electric motor or a hybrid motor. In this case of transport, the atmosphere outside the enclosure 11 delimited by the volume 16 (as illustrated in FIG. 1A), may be a compartment of the vehicle (as illustrated in FIG. 13A), for example a passenger compartment and/or goods compartment, whereas the enclosure 13 (the zone not occupied by passengers and/or goods) and the vent valve 15 allow venting over-pressurized and/or overheated gases to the outside of the vehicle. Thus, no over-pressurized and/or overheated gas can escape towards the passenger and/or goods compartment.

The vehicles represented in FIG. 13A-13D, each provided with a system according to the present invention as illustrated in FIG. 1A (alternatively, this could be a system as described above with reference to FIGS. 1B, 2, 3, or 4), can be:
of the type intended to transport people and/or goods; and/or
of the autonomous type; and/or
of the motor vehicle type 300 (FIG. 13A) and/or construction vehicle type, for example of the excavator or shovel loader type, or of the aircraft type (for example: aircraft 310, FIG. 13B), for example intended for extra-planetary transport, or of the space type, for example a space station or a satellite (in which case the external environment is a vacuum); or
alternatively, of the type used for maritime transport, for example a ship 320 (FIG. 13C), a vessel, a boat or a submarine, or of the type used for rail transport, for example a locomotive 330 (FIG. 13D) or a railroad car, or more generally of the type used as a means of air, land or sea travel.

In each of FIG. 13A-13D, the volume 140 is a compartment, for example a passenger and/or personnel compartment, with which the volume 11 can exchange a fluid via the element 12; however, other examples of a volume 140 can exist (for example a cargo hold or a containment area, or for example for transporting luggage and/or a material).

A device or a method according to the invention can also be used in a stationary application, for example to produce an energy production and storage system 400, as diagrammatically illustrated in FIG. 14, wherein the reference numeral 402 denotes a set of solar panels, and the reference numeral 404 denotes means or an electrical circuit for connecting this set to an energy storage device 30 (or 40) according to the invention (for example as described above with reference to FIG. 3 or 4). In this example, the outer casing is the casing 13. The solar panels 402 convert solar energy into electrical energy, which is stored in the device 30, 40. Alternatively (not shown in the figures), this may be a photovoltaic energy storage assembly, again for a stationary application, for example in a private home.

The example of solar energy has been considered hereinabove, but other means for producing energy (of the so-called “renewable” and/or intermittent energy type, for example of wind origin, or microhydraulic origin, or electrical energy resulting from a transformation by an industrial process-for example a co-generation-type process) may be implemented, associated with a storage device according to the invention.

In the case of the valves in FIG. 7A-7B or 8-11D, if overpressure and/or overheating (in the case of a thermal runaway for example) occurs, then a force is applied to the piston 152, 208 which opens (FIG. 7A-7B) the exhaust part or closes (FIG. 8-11D) the breathing valve, which, in both cases, avoids the bursting of or damage to the membrane dedicated to breathing; this protects the part dedicated to breathing throughout the life of the battery or energy storage element. In the case of a thermal runaway, the breathing valve, under the effect of the internal pressure and/or temperature or the pressure and/or temperature difference between the internal atmosphere and the external atmosphere, is thus protected as long as the applied pressure and/or temperature difference is greater than a limit value, for example greater than 50 mbar.

In a device or method according to the invention, as described above, at least one or more sensors for sensing the temperature and/or pressure and/or voltage across the terminals of the storage means 7 can be implemented, for example with a view to controlling one of these parameters in at least one of the volumes 11, 13, 16. This is the case, for example, in the context of controlling the atmosphere or gas in a volume 11 according to pressure and/or temperature or pressure and/or temperature differences. However, such control can also be carried out according to another type of signal or according to an external action, for example that of an operator, who wishes to control or test, for example in the context of a maintenance operation, the operation of a valve or of a plurality of valves of a device according to the invention. For example, an exhaust or breathing valve with a closing flap, can be provided with activation means such as means 290 adapted and/or programmed to close or open the valve or the flap depending on another type of signal, for example a change in pressure and/or temperature, for example during a predetermined time interval (such a change being compared to a limit value, or threshold, of change in pressure and/or temperature), or an external action triggered by an operator.

Alternatively, a valve or a flap of a valve of a device according to the invention can be activated to open or close in the case where a failure is detected: such a failure can be measured, for example in the case of an excessively high temperature of an enclosure such as, for example, the enclosure 11 or of a unit cell or of a set of electrochemical storage cells, for example a module or an enclosure as described above.

For example, the failure may be an abnormal temperature, for example 70° C. or more and/or an overvoltage and/or, on the contrary, a sudden drop in the voltage of the cell or of the energy storage device. The system can be provided with one or more corresponding sensors, for example for detecting voltage, and for example in addition to one or more sensors for detecting temperature and/or pressure that have already been described above.

In this embodiment, as in the preceding, the information provided by the one or more sensors can be transmitted to a control unit, for example the means 290 as already described above and/or computer means, for example a microcomputer, a processor or a microprocessor, to which the means 290 can be connected, for example.

1-26. (canceled)

27. An energy storage device to store electrochemical energy, comprising:
at least one first enclosure comprising a plurality of energy storage elements and at least one breathing element; and
at least one second enclosure, in a fluid communication with said at least one first enclosure and comprising an internal volume at least twice as large as that of said at least one first enclosure, at least one of first and second enclosures comprising or being provided with at least one venting element, said at least one second enclosure configured to receive and store a gas escaping from said at least one first enclosure via said at least one venting element or said at least one breathing element.

28. The device of claim 27, wherein said at least one second enclosure being in fluid communication with said at least one first enclosure to circulate the gas or an atmosphere from said at least one first enclosure towards said at least one second enclosure via at least one of: a duct, a hose, a tube and a channel.

29. The device of claim 28, wherein said at least one venting element being mounted at an inlet, inside, or at an outlet of said at least one of: the duct, the hose, the tube and the channel.

30. The device of claim 27, wherein said at least one second enclosure being in fluid communication with said at least one first enclosure via said at least one venting element mounted in a wall shared by said at least one first enclosure and said at least one second enclosure.

31. The device of claim 27, wherein said at least one first enclosure being contained in a third enclosure.

32. The device of claim 31, wherein the third enclosure is in a fluid communication with said at least one first enclosure via said at least one breathing element.

33. The device of claim 27, wherein each energy storage element forms a unique first enclosure and disposed in a module separated from each of neighboring modules by a wall, said at least one second enclosure comprising a venting element for each of said modules.

34. The device of claim 27, wherein at least one venting element is or comprises a valve, a flap, a seal or a breathing element.

35. The device of claim 27, wherein said at least one venting element is a breathing element, said at least one venting element comprises a first passage and a second passage, arranged in parallel, for a fluid entering or exiting said at least one of first and second enclosures provided with said at least one venting element; wherein the first passage comprises a piston movable between an open position and a closed position;
and the second passage comprises a fluid-permeable membrane.

36. The device of claim 35, wherein the piston is configured to open the first passage when a first pressure present in the first passage exceeds a first threshold, the fluid-permeable membrane is configured to rupture when a second pressure present in the second passage exceeds a second threshold, the first threshold being lower than the second threshold.

37. The device of claim 27, wherein at least one breathing element is or comprises a breathing valve or membrane, a felt or a foam or an opening and closing flap of said at least one breathing element.

38. The device of claim 27, wherein said at least one breathing element comprises a flap; and the device further comprising:
a body;
a membrane support to support a membrane to permit an atmospheric circulation between outside and inside of said at least one breathing element; and
an actuator to activate the flap between an open position of said at least one breathing element and a closed position of said at least one breathing element; wherein in the open position, the actuator permits the atmospheric circulation between the outside and inside of said at least one breathing element, and in the closing position, the actuator closes the atmospheric circulation.

39. The device of claim 38, wherein the actuator:
permits the atmospheric circulation when one of the following is below or equal to a limit value: at least one thermodynamic parameter of an internal atmosphere of said at least one breathing element, a difference in said at least one thermodynamic parameter between the internal atmosphere of said at least one breathing element and an external atmosphere of said at least one breathing element, or a change in said at least one thermodynamic parameter; and
closes the atmospheric circulation when one of the following is above the limit value: said at least one thermodynamic parameter, the difference in said at least one thermodynamic parameter, or the change in said at least one thermodynamic parameter;
wherein said at least one thermodynamic parameter comprises at least one of a pressure and a temperature.

40. The device of claim 27, wherein said at least one breathing element or said at least one venting element is provided with:
at least one filter; or
at least one filter disposed downstream of said at least one venting element, in a direction of flow of a fluid from an interior to an exterior of said at least one of first and second enclosures provided with said at least one venting element; or
at least one filter disposed upstream of said at least one breathing element, in a direction of flow of a fluid from an exterior to an interior of said at least one first enclosure.

41. The device of claim 27, further comprising a battery or a lithium-ion battery.

42. The device of claim 27, wherein said at least one venting element comprises an actuator to move or drive said at least one venting element or an opening or closing flap of said at least one venting element.

43. The device of claim 42, further comprising at least one of:
a pressure sensor to measure a pressure at least one of the following: inside of said at least one venting element, outside of said at least one venting element, inside of said at least one breathing element, outside of said at least one breathing element, inside of said at least one first enclosure, outside of said at least one first enclosure, inside of said at least one second enclosure, and outside of said at least one second enclosure;
a temperature sensor to measure a temperature at least one of the following: inside of said at least one venting element, outside of said at least one venting element, inside of said at least one breathing element, outside of said at least one breathing element, inside of said at least one first enclosure, outside of said at least one first enclosure, inside of said at least one second enclosure, and outside of said at least one second enclosure;
a voltage sensor to measure a voltage of said plurality of energy storage elements; and
measurements being provided to the actuator.

44. A vehicle comprising a compartment or a storage area, an engine, and at least one energy storage device of claim 27, at least one venting element to allow a gas to escape outside the compartment or storage area.

45. The vehicle of claim 44 is at least one of the following: a vehicle to transport at least one of people and goods; an autonomous vehicle; a motor vehicle; a construction vehicle; an excavator; a shovel loader; an aircraft; a spacecraft; a watercraft; a ship; a vessel; a boat; a submarine; a rail transport vehicle; a locomotive; and a railroad car.

46. A system to produce and store energy, comprising the energy storage device of claim 27, and an energy generator or transformer.
